(19) United States
(12) Patent Application Publication
(10) Pub. No.: US 2023/0403593 A1
(43) Pub. Date: Dec. 14, 2023

(54) MEASUREMENT GAP DETERMINATION METHOD, MEASUREMENT METHOD, RELATED DEVICE, AND STORAGE MEDIUM

(71) Applicant: Beijing Xiaomi Mobile Software Co., Ltd., Beijing (CN)

(72) Inventor: Wei HONG, Beijing (CN)

(21) Appl. No.: 18/250,318

(22) PCT Filed: Oct. 30, 2020
(86) PCT No.: PCT/CN2020/125577

§ 371 Date: Apr. 24, 2023

(51) Int. Cl. H04W 24/10; H04W 56/00

(52) U.S. Cl. CPC H04W 24/10; H04W 56/001

(57) ABSTRACT

A measurement gap determination method includes: determining a measurement gap for a terminal device based on a transmission delay difference between a serving cell and a neighboring cell. A measurement method includes: receiving measurement configuration information, and measuring, based on a measurement gap, a reference signal for a neighboring cell corresponding to a neighboring cell identifier.

### BACKGROUND

In an existing measurement gap configuration mode, a base station tacitly approves that transmission delay differences between a serving cell and neighboring cells are relatively small, and will ignore a transmission delay between the serving cell and a target cell when configuring a measurement gap for a terminal device.

### SUMMARY

The disclosure relates to the technical field of communications, in particular to a measurement gap determination method, a measurement method, a related device, and a storage medium.

Examples of the disclosure provide a measurement gap determination method, a measurement method, a related device, and a storage medium, such that a terminal device may complete measurement of reference signal for neighboring cell in the case of relatively large transmission delay difference between a serving cell and the neighboring cell, and has a high applicability.

In a first aspect, an example of the disclosure provides a measurement gap determination method, including:
determining measurement gaps for a terminal device based on transmission delay differences between a serving cell and neighboring cells.

In a second aspect, an example of the disclosure provides a measurement method, including:
receiving measurement configuration information, where the measurement configuration information includes measurement gaps and neighboring cell identifiers corresponding to the measurement gaps, and the measurement gaps are determined based on transmission delay differences between a serving cell and neighboring cells; and
measuring, based on the measurement gaps, reference signals for the neighboring cells corresponding to the neighboring cell identifiers.

In a third aspect, an example of the disclosure provides an electronic device, including a processor and a memory, the processor and the memory being mutually connected;
the memory being configured to store a computer program; and
the processor being configured to execute the method provided by any optional example of the first aspect or the second aspect when calling the computer program.

In a fourth aspect, an example of the disclosure provides a computer readable storage medium, where the computer readable storage medium stores a computer program, and the computer program is executed by a processor to implement the method provided by any possible example of the first aspect and/or the second aspect.

### BRIEF DESCRIPTION OF THE DRAWINGS

To more clearly illustrate technical solutions in examples of the disclosure, accompanying drawings used in the examples are simply introduced below, obviously, the described accompanying drawings are merely some examples of the disclosure, and those ordinarily skilled in the art may further acquire other accompanying drawings according to the accompanying drawings without paying creative labor.

FIG. 1 is a schematic process diagram of a measurement gap determination method provided by an example of the disclosure.

FIG. 2 is a schematic length contrast diagram of measurement gaps provided by an example of the disclosure.

FIG. 3 is a schematic length diagram of measurement gaps provided by an example of the disclosure.

FIG. 4 is a schematic structural diagram of a base station provided by an example of the disclosure.

FIG. 5 is a schematic structural diagram of a terminal device provided by an example of the disclosure.

FIG. 6 is a schematic structural diagram of an electronic device provided by an example of the disclosure.

### DETAILED DESCRIPTION

Technical solutions of examples of the disclosure will be clearly and completely described below in conjunction with the accompanying drawings of the examples of the disclosure. Obviously, the described examples are a part of the examples of the disclosure, not all of them. Based on the examples of the disclosure, all other examples obtained by those ordinarily skilled in the art without the need for creative labor fall within the scope of a protection of the disclosure.

In an existing measurement gap configuration mode, a base station tacitly approves that transmission delay differences between a serving cell and neighboring cells are relatively small, and will ignore a transmission delay between the serving cell and a target cell when configuring a measurement gap for a terminal device. However, in the case of the relatively large transmission delay differences between the serving cell and the neighboring cells, such as in a non-terrestrial networks (NTN) system, since the serving cell and the neighboring cells may correspond to different satellites, the transmission delay differences between the serving cell and the neighboring cells are relatively large under the influence of the satellite heights, which may reach hundreds of milliseconds to the maximum. In the case, if the transmission delay differences between the serving cell and the neighboring cells are not considered in the process of configuring the measurement gaps for the terminal device, the terminal device in the serving cell may miss an SSB based measurement timing configuration (SMTC) time window or channel-state information reference signal (CSI-RS) measurement resources, and may not complete the corresponding measurement of the neighboring cells.

As a consequence, the existing measurement gap configuration mode is optimized to solve the problem that since the delay differences between the serving cell and the neighboring cells are relatively large, reference signals for the neighboring cells cannot be measured.

A terminal device in an example of the disclosure may be a device that provides voice and/or data connectivity to a user, a handheld device with a wireless connectivity function, or other processing devices connected to wireless modems, as well as a terminal in a future 5G system or a terminal device in a future evolving public land mobile network (PLMN), or other devices. In different systems, names of the terminal device may also be different, for example, in the 5G system, the terminal device may be called user equipment (UE). The terminal device may also be a wireless terminal device in communication with one or more core networks (CNs) through a radio access network (RAN), the wireless terminal device may be a mobile terminal device, such as a mobile phone (or called a “cellular” phone) and a computer with the mobile terminal device, for example, the terminal device may be a portable, pocket, handheld, computer built in, or vehicle-mounted mobile device, and the terminal device exchanges languages and/or data with the RAN. For example, the terminal device may be a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety, a wireless terminal in smart city, or a wireless terminal personal communication service (PCS) phone in smart home, a cordless phone, a session initiated protocol (SIP) phone, a wireless local loop (WLL) station, a personal digital assistant (PDA), etc., which is not limited in the example of the disclosure. The wireless terminal device may also be called a system, a subscriber unit, a subscriber station, a mobile station, a mobile station, a remote station, an access point, a remote terminal, an access terminal device, a user terminal device, a user agent, and a user device, which is not limited in the example of the disclosure.

A base station in an example of the disclosure may also be called an access point, or a device communicating with a wireless terminal device through one or more sectors on an air interface in an access network or other names. The base station in the example of the disclosure may be NodeB in a global system of mobile communication (GSM) system, a code division multiple access (CDMA) system and a wideband code division multiple access (WCDMA) system, may also be an evolutional NodeB (eNB or e-NodeB) in a long term evolution (LTE) system, a 5G base station (gNB) in a 5G network architecture, may also be a home evolved NodeB (HeNB), a relay node, a femto, pico, etc., which is not limited in the example of the disclosure.

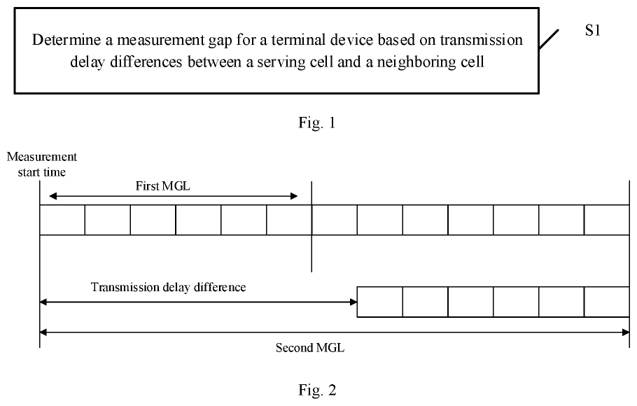

Referring to FIG. 1, FIG. 1 is a schematic process diagram of a measurement gap determination method provided by an example of the disclosure, the method is executed by a base station corresponding to a serving cell, and the method specifically includes:

S1: a measurement gap for a terminal device is determined based on transmission delay difference between the serving cell and a neighboring cell.

In some examples, the base station corresponding to the serving cell obtains transmission delay of the neighboring cell through an Xn interface, and the transmission delay difference between the serving cell and the neighboring cell is determined based on the transmission delay of the neighboring cell and a transmission delay of a serving cell.

Optionally, the transmission delay difference between the serving cell and the neighboring cell may be determined by base station corresponding to the neighboring cell, and the base station corresponding to the serving cell obtains the transmission delay difference, sent by the base station corresponding to the neighboring cell, between the serving cell and the neighboring cells through the Xn interface.

Optionally, the base station corresponding to the serving cell obtains ephemeris information of the satellite corresponding to the neighboring cell through the Xn interface, the transmission delay of the neighboring cell is determined based on the ephemeris information, and the transmission delay difference between the serving cell and the neighboring cell is further determined based on the transmission delay of the neighboring cell.

The ephemeris information of the neighboring cell includes at least one of the following:
satellite height of the satellite corresponding to the neighboring cell; and
transmission delay of the satellite corresponding to the neighboring cell.

The ephemeris information of the neighboring cell may further include other information which may determine the transmission delay of the neighboring cell, and specifically, determination may be performed based on requirements of a practical application scenario, which is not limited here.

As an optional example, the base station corresponding to the serving cell determines the transmission delay of the neighboring cell based on the satellite height, included in the ephemeris information, of the satellite corresponding to the neighboring cell, and then determines the transmission delay difference between the serving cell and the neighboring cell based on the transmission delay corresponding to the neighboring cell.

As an optional example, the base station corresponding to the serving cell determines transmission delay of the satellite corresponding to the neighboring cell based on the ephemeris information and then determines the transmission delay of the neighboring cell based on the transmission delay of the satellite, so as to determine the transmission delay difference between the serving cell and the neighboring cell based on the transmission delay of the neighboring cell.

The satellites corresponding to all the cells in the example of the disclosure may be a geostationary earth orbiting (GEO) satellite, a low earth orbiting (LEO) satellite and a medium earth orbiting (MEO) satellite, etc. in non-terrestrial networks (NTNs), and specifically, determination may be performed based on the requirements of the practical application scenario, which is not limited here.

Optionally, the transmission delay of the serving cell may be determined by the base station corresponding to the serving cell, and specifically, the transmission delay may be determined based on the ephemeris information of the satellite corresponding to the serving cell and other related transmission data, which is not limited here.

Different cells possibly correspond to the same satellite and may also correspond to different satellites respectively, which is not limited here.

In some examples, the measurement gap of the terminal device includes a measurement gap length (MGL). That is, when the base station corresponding to the serving cell configures the measurement gap to the terminal device, the MGL is configured to the terminal device, such that the terminal device, based on the MGL included in the measurement gap, measures the reference signal for the neighboring cell.

The MGL includes the transmission delay differences between the serving cell and the neighboring cell, in other words, the duration of configuring the MGL based on the transmission delay difference between the serving cell and the neighboring cell is greater than the duration of the MGL when terminal device is configured to measure the reference signal for the neighboring cell in the case that the transmission delay difference between the serving cell and the neighboring cell is not considered.

In other words, the time span of the MGL configured by the base station corresponding to the serving cell to the terminal device based on the transmission delay difference between the serving cell and the neighboring cell is larger than that of the MGL adopted by the terminal device in the case that the transmission delay difference between the serving cell and the neighboring cell is not considered. Based on the excess duration by configuring the MGL based on the transmission delay differences being greater than or equal to the transmission delay difference between the serving cell and the neighboring cell, when the terminal device measures, based on the MGL configured by the transmission delay difference, the reference signal for the neighboring cell, the terminal device starts measurement after at least waiting not less than the duration of the transmission delay difference, which eliminates the influences of the transmission delay difference between the serving cell and the neighboring cell on the measurement of the neighboring cell.

In the examples of the disclosure, the base station may determine the measurement gaps of the terminal device based on the transmission delay difference between the serving cell and the neighboring cell, such that the terminal device completes measurement for the reference signals for the neighboring cell in the case of the relatively large transmission delay difference between the serving cell and the neighboring cell, and has the high applicability.

Referring to FIG. 2, FIG. 2 is a schematic length contrast diagram of measurement gaps provided by an example of the disclosure. The first MGL shown in FIG. 2 is the MGL configured for the terminal device in the case that the base station corresponding to the serving cell ignores the transmission delay differences between the serving cell and the neighboring cell. In the case that the transmission delay difference between the serving cell and the neighboring cell is minimum, the base station may ignore the transmission delay difference between the serving cell and the neighboring cell, and then the terminal device may measure, based on the first MGL, the reference signal for the neighboring cell. In the case that the transmission delay difference between the serving cell and the neighboring cell is relatively large, since the transmission delay difference is ignored during configuring the first MGL, when the terminal device measures, based on the first MGL, the reference signal for the neighboring cell, the terminal device may miss an SMTC time window or a CSI-RS measurement resource under the influence of the transmission delay difference, and then, the terminal device cannot measure the reference signal for the neighboring cell.

Based on this, a second MGL shown in FIG. 2 is the MGL configured by the base station corresponding to the serving cell for the terminal device based on the transmission delay difference between the serving cell and the neighboring cell. The second MGL includes the transmission delay difference between the serving cell and the neighboring cell, and when the terminal device measures, based on the second MGL, the reference signal for the neighboring cell, the terminal device may have waiting time not less than the transmission delay differences to wait the SMTC time window or the CSI-RS measurement resource, so as to successfully measure the reference signal for the neighboring cell.

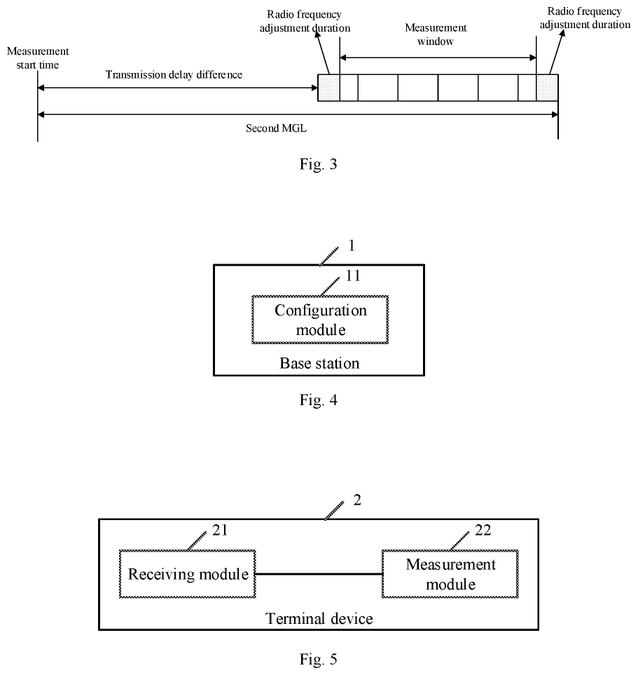

Each MGL further includes a measurement window duration and a radio frequency adjustment duration. As shown in FIG. 3, FIG. 3 is a schematic length diagram of measurement gap provided by an example of the disclosure. In FIG. 3, the second MGL is the MGL configured by the base station corresponding to the serving cell based on the transmission delay difference between the serving cell and the neighboring cell, that is, the complete measurement gap length of the terminal device. The terminal device may wait the SMTC time window or the CSI-RS measurement resource in the duration not less than the duration corresponding to the transmission delay difference, and measures the reference signal for the neighboring cell on the measurement time window.

It is further known that the MGL configured by the base station corresponding to the serving cell based on the transmission delay differences between the serving cell and the neighboring cell includes the transmission delay difference between the serving cell and the neighboring cell, the radio frequency adjustment duration and the measurement window duration. That is, the MGL configured by the base station corresponding to the serving cell is greater than or equal to a sum of the transmission delay difference between the serving cell and the neighboring cell, the radio frequency adjustment duration and the measurement window duration in time span.

When the terminal device measures, based on the measurement gap, the reference signals for all the neighboring cells, the measurement window durations corresponding to the neighboring cells are the same, and then the MGL configured by the base station corresponding to the serving cell has at least one more time span of the transmission delay difference than the corresponding MGL without considering the transmission delay difference.

The measurement time window may be an SMTC time window, that is, the time window used for measuring a synchronization signal and PBCH block (SSB) signal, and the measurement time window may also be a time window used for measuring CSI-RS, which is not limited here.

In some examples, the measurement gap in the example of the disclosure includes a measurement gap offset. The measurement gap offset is configured by the base station corresponding to the serving cell based on the transmission delay difference.

The measurement gap offset is used for determining a start frame number of the measurement gap, that is, the terminal device may determine a start moment of the measurement gap based on the measurement gap offset, and then measure, based on the start moment of the measurement gap, the reference signal for the neighboring cell.

The smaller the transmission delay difference between the serving cell and the neighboring cell, the earlier the terminal device starts the measurement gap. On the contrary, the larger the transmission delay difference between the serving cell and the neighboring cell, the later the terminal device starts the measurement gap. The base station corresponding to the serving cell determines the measurement gap offset included in the measurement gap based on a relation between the measurement gap offset and the transmission delay difference.

A range of the measurement gap offset is 0 ms to 159 ms, and a determination condition of the measurement gap offset is that the start moment of the measurement gap corresponding to the measurement gap offset configured by the base station corresponding to the serving cell is not later than receiving time corresponding to the SMTC time window or the CSI-RS measurement resource.

On this basis, a specific offset of the measurement gap offset may be determined based on the requirements of the practical application scenario, which is not limited here.

In some examples, the measurement gap of the terminal device may include the MGL and the measurement gap offset at the same time, that is, the base station corresponding to the serving cell may configure the MGL and the measurement gap offset for the terminal device based on the transmission delay differences between the serving cell and the neighboring cell at the same time, and a specific configuration mode is shown above, which is not repeated here. So that, the terminal device may determine the start moment of the measurement gap based on the measurement gap offset, so as to measure the reference signal for the neighboring cell based on the MGL.

In some examples, the serving cell often has a plurality of neighboring cells, so that the measurement gap determination method provided by the example of the disclosure further includes:

the neighboring cells are grouped based on the transmission delay differences corresponding to the neighboring cells, and the measurement gap is configured for each group of neighboring cells.

Specifically, the neighboring cells with the transmission delay differences less than or equal to transmission delay difference threshold values are divided into one group according to the transmission delay differences corresponding to the neighboring cells.

When the neighboring cells are grouped based on the transmission delay differences corresponding to the neighboring cells, and the neighboring cells may be grouped based on the transmission delay difference threshold values.

Determination of the transmission delay difference threshold values may be determined by the base station corresponding to the serving cell based on the practical application scenario, which is not limited here.

For the plurality of transmission delay difference threshold values, such as a first transmission delay difference threshold value, a second transmission delay difference threshold value and a third transmission delay difference threshold value, the first transmission delay difference threshold value is less than the second transmission delay difference threshold value, and the second transmission delay difference threshold value is less than the third transmission delay difference threshold value. When grouping is performed according to the transmission delay differences corresponding to the neighboring cells, the neighboring cells with the transmission delay differences less than or equal to the first transmission delay difference threshold value are divided into one group, the neighboring cells with the transmission delay differences greater than the first transmission delay difference threshold value and less than or equal to the second transmission delay difference threshold value are divided into one group, the neighboring cells with the transmission delay differences greater than the second transmission delay difference threshold value and less than or equal to the third transmission delay difference threshold value are divided into one group, and the neighboring cells with the transmission delay differences greater than the third transmission delay difference threshold value are determined as one group.

Furthermore, after the neighboring cells are grouped based on the transmission delay differences corresponding to the neighboring cells, the measurement gap may be configured for each group of neighboring cells. That is, each group of neighboring cells corresponds to one measurement gap, and the terminal device may measure the reference signals for the neighboring cells corresponding to the measurement gap through one measurement gap.

For example, the neighboring cell cell-1, the neighboring cell cell-2 and the neighboring cell cell-3 are the same group of neighboring cells, and the base station corresponding to the serving cell may configure the same measurement gap for the neighboring cell cell-1, the neighboring cell cell-2 and the neighboring cell cell-3. Then, the terminal device may measure, based on the measurement gap, the reference signals for the neighboring cell cell-1, the neighboring cell cell-2 and the neighboring cell cell-3 respectively.

The measurement gap corresponding to each group of neighboring cells includes the MGL, and the MGL corresponding to each group of neighboring cells includes a maximum transmission delay difference in the transmission delay differences corresponding to the group of neighboring cells. On this basis, the MGL corresponding to the group of neighboring cells may include the transmission delay difference corresponding to any neighboring cell in the group of neighboring cells. In other words, when the base station corresponding to the serving cell configures the measurement gap for the group of neighboring cells, the maximum transmission delay difference in the transmission delay differences corresponding to the group of neighboring cells may be determined, and the MGL included in the measurement gap is determined based on the maximum transmission delay difference corresponding to the group of neighboring cells.

Based on the above implementation mode, when the terminal device measures, based on the measurement gap, the reference signal for any neighboring cell in the group of neighboring cells, the terminal device has the enough MGL to wait the SMTC time window or CSI-RS measurement resources. That is, when the terminal device measures, based on the measurement gap of the group of neighboring cells, the reference signal for any neighboring cell in the group of neighboring cells, the terminal device may wait the SMTC time window or CSI-RS measurement resources corresponding to the neighboring cell within the duration not less than the duration corresponding to the transmission delay difference corresponding to any neighboring cell, and then for any neighboring cell, the terminal device may successfully measure the reference signal for the neighboring cell.

Optionally, after the neighboring cells are grouped based on the transmission delay differences corresponding to the neighboring cells, the measurement gap offset may be configured for each group of neighboring cells. That is, each group of neighboring cells corresponds to one measurement gap offset, and the terminal device may take the start moment of the measurement gap determined by the measurement gap offset as the start moment of the measurement gap corresponding to any neighboring cell in the group of neighboring cells, so as to measure, based on the start moment of the same measurement gap, the reference signal for any neighboring cell in the group of neighboring cells.

For example, the neighboring cell cell-1, the neighboring cell cell-2 and the neighboring cell cell-3 are the same group of neighboring cells, and the base station may configure the same measurement gap offset for the neighboring cell cell-1, the neighboring cell cell-2 and the neighboring cell cell-3. Then, the terminal device may determine the start moment of the measurement gap corresponding to any neighboring cell in the group of neighboring cells, so as to measure the reference signals for the neighboring cell cell-1, the neighboring cell cell-2 and the neighboring cell cell-3 respectively.

The measurement gap corresponding to each group of neighboring cells includes one measurement gap offset, and the measurement gap offset corresponding to each group of neighboring cells is configured based on a minimum transmission delay difference in the transmission delay differences corresponding to the group of neighboring cells.

In other words, when the base station corresponding to the serving cell configures the measurement gap for the group of neighboring cells, the minimum transmission delay difference in the transmission delay differences corresponding to the group of neighboring cells may be determined, and then it is determined that the measurement gap offset included in the measurement gap is determined based on the minimum transmission delay difference.

The smaller the transmission delay difference between the serving cell and any neighboring cells, the earlier the terminal device starts the measurement gap. On the contrary, the larger the transmission delay difference between the serving cell and any neighboring cell, the later the terminal device starts the measurement gap. As a result, the start moment of the measurement gap corresponding to the measurement gap offset determined based on the minimum transmission delay difference in the transmission delay differences corresponding to each group of neighboring cells is the earliest start moment of all the neighboring cells in the group of neighboring cells, and the reference signals for all the neighboring cells in the group of neighboring cells may be successfully measured.

All the neighboring cells in the group of neighboring cells correspond to the start moment of the same measurement gap, and the terminal device measures, based on the start moment of the same measurement gap, the reference signals for all the neighboring cells in the group of neighboring cells.

In some examples, when all the neighboring cells are grouped based on the transmission delay differences corresponding to the neighboring cells, the neighboring cells with the transmission delay differences less than or equal to the transmission delay difference threshold values may further be divided into one group, one MGL is configured for the group of neighboring cells based on the maximum transmission delay difference corresponding to the group of neighboring cells, and/or one measurement gap offset is configured for the group of neighboring cells based on the minimum transmission delay difference corresponding to the group of neighboring cells.

For the neighboring cells with the transmission delay differences larger than the transmission delay difference threshold values, one MGL and/or the measurement gap offset are/is configured for each neighboring cell respectively.

Similarly, For the plurality of transmission delay difference threshold values, such as the first transmission delay difference threshold value and the second transmission delay difference threshold value, and the first transmission delay difference threshold value is less than the second transmission delay difference threshold value. When grouping is performed according to the transmission delay differences corresponding to the neighboring cells, the neighboring cells with the transmission delay differences less than or equal to the first transmission delay difference threshold value are divided into one group, and the neighboring cells with the transmission delay differences greater than the first transmission delay difference threshold value and less than or equal to the second transmission delay difference threshold value are divided into one group.

For each group of neighboring cells, one MGL is configured for the group of neighboring cells based on the maximum transmission delay difference corresponding to the group of neighboring cells, and/or one measurement gap offset is configured for the group of neighboring cells based on the minimum transmission delay difference corresponding to the group of neighboring cells.

Furthermore, for the neighboring cells with the transmission delay differences greater than the second transmission delay difference threshold value, one MGL and/or one measurement gap offset are/is configured for each neighboring cell respectively based on the transmission delay differences corresponding to the neighboring cells.

As an optional example, the base station corresponding to the serving cell obtains the ephemeris information of the satellites of the neighboring cells through the Xn interface.

The base station corresponding to the serving cell determines the transmission delay differences between the serving cell and the neighboring cells through the ephemeris information, for example, the ephemeris information includes height information of the satellites corresponding to the neighboring cells, and the base station corresponding to the serving cell determines the transmission delays of the neighboring cells according to the height information and then determines the transmission delay differences between the serving cell and the neighboring cells according to the transmission delays of the neighboring cells. For another example, the ephemeris information includes the transmission delays of the neighboring cells, and the base station corresponding to the serving cell determines the transmission delay differences between the serving cell and the neighboring cells according to the transmission delays of the neighboring cells.

Furthermore, the base station corresponding to the serving cell determines the measurement gap of the terminal device through two following modes based on the transmission delay differences.

As an optional mode, the base station corresponding to the serving cell may determine the longer MGL for the terminal device, that is, the measurement gap determined for the terminal device has a larger gap length compared with a MGL adopted by the terminal device without considering the transmission delay differences.

The measurement gap of the terminal device includes the transmission delay differences between the serving cell and the neighboring cells.

As an optional mode, the base station corresponding to the serving cell may configure the measurement gap offset for the measurement gap of the terminal device. The base station configures the measurement gap offset based on the transmission delay differences between the serving cell and the neighboring cells.

Furthermore, if the terminal device needs to measure the plurality of neighboring cells, the base station corresponding to the serving cell may obtain the transmission delay differences ΔTᵢ between the serving cell and the neighboring cells through the Xn interface, and i is indexes of the neighboring cells.

Furthermore, the base station corresponding to the serving cell may set different transmission delay difference threshold values T1, T2 . . . Tn, and the neighboring cells with the transmission delay differences less than or equal to T1, T2 . . . Tn are divided into different groups G1, G2, . . . Gn. Correspondingly, the measurement gaps, Gap Pattern #1, Gap Pattern #2, . . . Gap Pattern #n are respectively configured for the different groups G1, G2, . . . Gn corresponding to the serving cell. A measurement gap combination includes an MGL and/or a measurement gap offset.

One group of neighboring cells corresponds to one measurement gap, that is, each group of all the corresponding neighboring cells corresponds to one MGL and/or one measurement gap offset.

When the base station corresponding to the serving cell determines the measurement gap offset corresponding to each group, the base station considers a minimum value min(ΔT_{i,G}) of the transmission delay differences in all the groups. That is, for each group of neighboring cells, when the base station corresponding to the serving cell determines the measurement gap offset corresponding to the group, determination may be performed according to the minimum transmission delay difference in the transmission delay differences corresponding to the group of neighboring cells.

When the base station corresponding to the serving cell determines the MGL corresponding to each group, the base station considers the maximum value max(ΔT_{m,G}_{ₙ}) of the transmission delay differences in all the groups. That is, for each group of neighboring cells, when the base station corresponding to the serving cell determines the MGL corresponding to the group, determination may be performed according to the maximum transmission delay difference in the transmission delay differences corresponding to the group of neighboring cells.

As a result, the problem that due to the transmission delay differences between the serving cell and the neighboring cells, the terminal device misses the SMTC time window or CSI-RS measurement resources and cannot complete corresponding measurement may be effectively solved. Meanwhile, the problem that mobile measurement is inaccurate or mobile measurement cannot be performed due to the transmission delays may be effectively solved, and reliability of mobile management is improved.

An example of the disclosure further provides a measurement method. The method is executed by a terminal device in a serving cell and specifically includes:
measurement configuration information is received, the measurement configuration information includes measurement gaps and neighboring cell identifiers corresponding to the measurement gaps, and the measurement gaps are determined by a base station corresponding to the serving cell based on transmission delay differences between the serving cell and neighboring cells; and
reference signals for the neighboring cells corresponding to the neighboring cell identifiers are measured based on the measurement gaps.

Optionally, each measurement gap includes a measurement gap length (MGL), and measuring, based on the measurement gaps, the reference signals for the neighboring cells corresponding to the neighboring cell identifiers includes:
the reference signals for the neighboring cells corresponding to the neighboring cell identifiers are measured based on the MGL.

Optionally, each MGL includes the transmission delay differences.

Optionally, each MGL further includes a measurement window duration and a radio frequency adjustment duration.

Optionally, each measurement gap includes a measurement gap offset, the measurement gap offset is configured based on the transmission delay differences, and measuring, based on the measurement gap, the reference signals for the neighboring cells corresponding to the neighboring cell identifiers includes:

a start moment of the measurement gap is determined based on the measurement gap offset, and the reference signals for the neighboring cells corresponding to the neighboring cell identifiers are measured based on the start moment.

Specifically, when a terminal device measures, based on the measurement gap, the reference signals for the neighboring cells corresponding to the neighboring cell identifiers, measurement may be performed based on the MGL included in the measurement gap, and/or, the terminal device determines the start moment of the measurement gap based on the measurement gap offset, and measurement is performed based on the start moment of the measurement gap.

Optionally, a plurality of groups of neighboring cells are arranged, each group of neighboring cells corresponds to one measurement gap, and measuring, based on the measurement gap, the reference signals for the neighboring cells corresponding to the neighboring cell identifiers includes:

for each group of neighboring cells, the reference signals for the group of neighboring cells are measured based on the measurement gap corresponding to the group of neighboring cells and the neighboring cell identifiers corresponding to the measurement gap.

Optionally, the measurement gap corresponding to each group of neighboring cells includes the MGL, and the MGL corresponding to each group of neighboring cells includes a maximum transmission delay difference in the transmission delay differences corresponding to the group of neighboring cells.

Optionally, the measurement gap corresponding to each group of neighboring cells includes a measurement gap offset, and the measurement gap offset corresponding to each group of neighboring cells is configured based on a minimum transmission delay difference in the transmission delay differences corresponding to the group of neighboring cells.

Specifically, the terminal device responds to a plurality of pieces of measurement configuration information, and the reference signals for the neighboring cells corresponding to the neighboring cell identifiers corresponding to the measurement configuration information are measured based on the measurement gap included in each piece of measurement configuration information.

In response to the measurement gap included in the same measurement configuration information corresponding to the plurality of neighboring cells, the reference signals for the corresponding neighboring cells are measured based on the measurement gap.

Detailed descriptions of the above optional examples in the measurement method performed by the terminal device and descriptions of relevant terms in each optional example may refer to descriptions in corresponding parts in the optional examples in the measurement gap determination method performed by the base station in the preceding paragraph, which is not repeated here.

In the example of the disclosure, in the case of the relatively large transmission delay differences between the serving cell and the neighboring cells, the terminal device completes measurement of the reference signals for the neighboring cells based on the measurement gap configured by the base station, and has the high applicability.

Referring to FIG. 4, FIG. 4 is a schematic structural diagram of a base station provided by an example of the disclosure. The base station 1 provided by the example of the disclosure includes:
a configuration module 11, configured to determine a measurement gap for a terminal device based on transmission delay differences between a serving cell and neighboring cells.

In some examples, the measurement gap includes a measurement gap length (MGL), and the MGL includes the transmission delay differences.

In some examples, the MGL further includes a measurement window duration and a radio frequency adjustment duration.

In some examples, the measurement gap includes a measurement gap offset, and the measurement gap offset is configured based on the transmission delay differences.

In some examples, the plurality of neighboring cells are arranged, and the configuration module 11 is further configured to:

group the neighboring cells based on the transmission delay differences corresponding to the neighboring cells, and respectively configure the measurement gap for each group of neighboring cells.

In some examples, the configuration module 11 is configured to:

divide the neighboring cells with the transmission delay differences less than or equal to the transmission delay difference threshold values into one group according to the transmission delay differences corresponding to the neighboring cells.

In some examples, the measurement gap includes the MGL, and the MGL corresponding to each group of neighboring cells includes a maximum transmission delay difference in the transmission delay differences corresponding to the group of neighboring cells.

In some examples, the measurement gap includes the measurement gap offset, and the measurement gap offset corresponding to each group of neighboring cells is configured based on a minimum transmission delay difference in the transmission delay differences corresponding to the group of neighboring cells.

In some examples, the configuration module 11 is configured to:
obtain transmission delays of the neighboring cells through an Xn interface; and
determine the transmission delay differences between the serving cell and the neighboring cells based on the transmission delays of the neighboring cells.

In the specific implementation, the base station 1 may execute implementation modes provided by all the steps in the FIG. 1 through all function modules built in the base station, and specifically refer to the implementation modes provided by all the above steps, which is not repeated here.

Referring to FIG. 5, FIG. 5 is a schematic structural diagram of a terminal device provided by an example of the disclosure. The terminal device 2 provided by the example of the disclosure includes:
a receiving module 21, configured to receive measurement configuration information, where the measurement configuration information includes measurement gaps and neighboring cell identifiers corresponding to the measurement gaps, and the measurement gaps are determined based on transmission delay differences between a serving cell and neighboring cells; and
a measurement module 22, configured to measure, based on the measurement gaps, reference signals for the neighboring cells corresponding to the neighboring cell identifiers.

In some examples, each measurement gap includes a measurement gap length (MGL), and the MGL includes the transmission delay differences.

In some examples, the MGL further includes a measurement window duration and a radio frequency adjustment duration.

In some examples, each measurement gap includes a measurement gap offset, the measurement gap offset is configured based on the transmission delay differences, and the measurement module 22 is configured to:
determine a start moment of the measurement gap based on the measurement gap offset, and measure reference signals for the neighboring cells corresponding to the neighboring cell identifiers based on the start moment.

In some examples, the plurality of groups of neighboring cells are arranged, each group of neighboring cells corresponds to one measurement gap respectively, and the measurement module 22 is configured to:
for each measurement gap, measure, based on the measurement gap and the neighboring cell identifiers corresponding to the measurement gap, the reference signals for the group of neighboring cells corresponding to the measurement gap.

In some examples, the measurement gap corresponding to each group of neighboring cells includes the MGL, and the MGL corresponding to each group of neighboring cells includes the maximum transmission delay difference in the transmission delay differences corresponding to the group of neighboring cells.

In some examples, the measurement gap corresponding to each group of neighboring cells includes the measurement gap offset, and the measurement gap offset corresponding to each group of neighboring cells is configured based on the minimum transmission delay difference in the transmission delay differences corresponding to the group of neighboring cells.

In the specific implementation, the terminal device 2 may execute implementation modes provided by all the optional examples in the measurement method executed by the terminal device through all the function modules built in the terminal device and specifically may refer to the implementation modes provided by all the above steps, which is not repeated here.

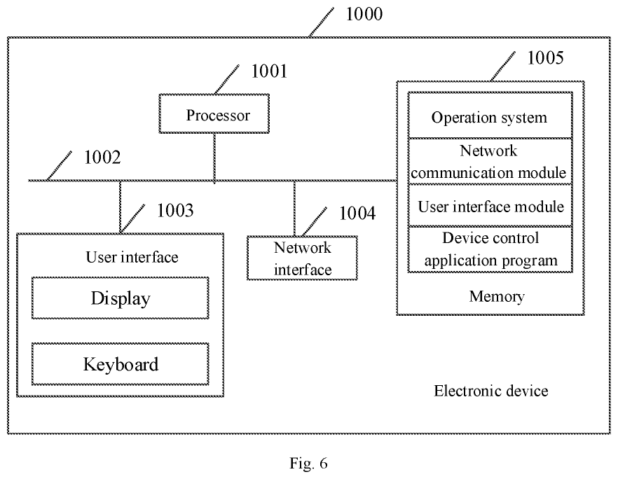

Referring to FIG. 6, FIG. 6 is a schematic structural diagram of an electronic device provided by an example of the disclosure. As shown in FIG. 6, the electronic device 1000 in the example may include a processor 1001, a network interface 1004 and a memory 1005. In addition, the above electronic device 1000 may further include a user interface 1003 and at least one communication bus 1002. The communication bus 1002 is configured to achieve connection communication between the components. The user interface 1003 may include a display and a keyboard, the optional user interface 1003 may further include a standard wired interface and a standard wireless interface. The network interface 1004 optionally may include a standard wired interface and a standard wireless interface (such as a WI-FI interface). The memory 1004 may be a high-speed RAM, and may also be a non-volatile memory, such as at least one disk memory. The memory 1005 may further be at least one storage apparatus located away from the above processor 1001 optionally. As shown in FIG. 6, the memory 1005 serving as a computer readable storage medium may include an operation system, a network communication module, a user interface module and a device control application program.

In the electronic device 1000 shown in FIG. 6, the network interface 1004 may provide a network communication function, the user interface 1003 is mainly configured to provide an input interface for a user, and the processor 1001 may be configured to call a device control application program stored in the memory 1005, so as to implement the measurement gap determination method executed by the base station in the example of the disclosure or implement the measurement method executed by the terminal device in the example of the disclosure.

It will be understood that in some examples, the above processor 1001 may be a central processing unit (CPU), the processor may further be other general-purpose processors, a digital signal processor (DSP), an application specific integrated circuit (ASIC), a field-programmable gate array (FPGA) or other programmable logic devices, separate gate or transistor logic devices, a separate hardware assembly, etc. The general-purpose processor may be a micro-processor, or the processor may also be any conventional processor, etc. The memory may include a read-only memory and a random access memory and provides instructions and data for the processor. One part of the memory may further include a non-volatile random access memory, for example, the memory may further store device type information.

An example of the disclosure further provides a computer readable storage medium, the computer readable storage medium stores a computer program, the computer readable storage medium is executed by the processor to implement the measurement gap determination method executed by the base station in the example of the disclosure or implement the measurement method executed by the terminal device in the example of the disclosure, and specifically the computer readable storage medium may refer to the implementation modes provided by all the steps, which is not repeated here.

The above computer readable storage medium may be any of the base station, the terminal device or an internal storage unit of the electronic device, such as a hard disk or memory of the electronic device. The computer readable storage medium may also be an external storage device of the electronic device, such as a plug-in hard disk, a smart media card (SMC), a secure digital (SD) card and a flash card equipped with the electronic device. The computer readable storage medium may also include a magnetic disk, an optical disk, a read-only memory (ROM) or a random access memory (RAM), etc. Furthermore, the computer readable storage medium may also include both the internal storage unit of the electronic device and the external storage device. The computer readable storage medium is used to store the computer program and other programs and data required by the electronic device. The computer readable storage medium can also be used to temporarily store data that has been or will be output.

Terms “first” and “second” in the claim, specification and accompanying drawings of the disclosure are used to distinguish different objects and not to describe a specific sequence. Furthermore, terms “include” and “have” and any variation of them are intended to cover non-exclusive inclusion. For example, a process, method, system, product or electronic device including a series of steps or units is not limited to listed steps or units, but optionally further includes steps or units not listed, or optionally further includes other steps or units inherent to the process, method, product or electronic device. Reference to “examples” mentioned in the disclosure means that a particular feature, structure or characteristic described in conjunction with the examples may be included in at least one of the examples of the disclosure. The presentation of phrases at various locations in the specification does not necessarily refer to the same example or to a separate or alternative example that is mutually exclusive with other examples. It is understood, both explicitly and implicitly, by those skilled in the art that the examples described in the disclosure may be combined with other examples. The term “and/or” used in the specification and appended claim of the disclosure means any combination and all possible combinations of one or more of related items listed, and includes the combinations.

Those ordinarily skilled in the art may aware that units and algorithmic steps of each example described in combination with the examples in the disclosure may be implemented in electronic hardware, computer software, or a combination of both. In order to clearly illustrate the interchangeability of hardware and software, the composition and steps of professionals may use different methods to implement the described functionality for each particular application, but such implementation should not be considered outside the scope of the disclosure.

The above disclosure is merely a better example of the disclosure, and cannot be used to limit the claim scope of the disclosure, so the equivalent changes done in accordance with the claim of the disclosure still belong to the scope of the disclosure.

1. A measurement gap determination method, performed by a base station and comprising:
determining a measurement gap for a terminal device base on a transmission delay difference between a serving cell and a neighboring cell.

2. The measurement gap determination method according to claim 1, wherein the measurement gap comprises a measurement gap length (MGL), and the MGL comprises the transmission delay difference.

3. The measurement gap determination method according to claim 2, wherein the MGL further comprises a measurement window duration and a radio frequency adjustment duration.

4. The measurement gap determination method according to claim 1, wherein the measurement gap comprises a measurement gap offset, and the measurement gap offset is configured based on the transmission delay difference.

5. The measurement gap determination method according to claim 1, wherein a plurality of neighboring cells are arranged, and the measurement gap determination method further comprises:
grouping the plurality of neighboring cells based on transmission delay differences corresponding to the neighboring cells, and configuring the measurement gap for at least one group of the plurality of neighboring cells.

6. The measurement gap determination method according to claim wherein grouping the neighboring cells based on the transmission delay differences of the neighboring cells comprises:
dividing neighboring cells with transmission delay difference less than or equal to a transmission delay difference threshold value into one group according to the transmission delay differences corresponding to the neighboring cells.

7. The measurement gap determination method according to claim wherein the measurement gap comprises an MGL, and the MGL corresponding to one group of neighboring cells comprises a maximum transmission delay difference in the transmission delay differences corresponding to the at least one group of the plurality of neighboring cells.

8. The measurement gap determination method according to claim wherein the measurement gap comprises a measurement gap offset, and the measurement gap offset corresponding to one group of neighboring cells is configured based on a minimum transmission delay difference in the transmission delay differences corresponding to the at least one group of the plurality of neighboring cells.

9. The measurement gap determination method according to claim 1, further comprising:
obtaining transmission delay of the neighboring cell through an Xn interface; and
determining the transmission delay difference between the serving cell and the neighboring cell based on the transmission delay of the neighboring cell.

10. A measurement method, performed by a terminal device, and comprising:
receiving a measurement configuration information, wherein the measurement configuration information comprises a measurement gap and a neighboring cell identifier corresponding to the measurement gap, and the measurement gap is determined based on a transmission delay difference between a serving cell and a neighboring cell; and
measuring, based on the measurement gap, a reference signal for the neighboring cell corresponding to the neighboring cell identifier.

11. The measurement method according to claim 10, wherein the measurement gap comprises a measurement gap length (MGL), and the MGL comprises the transmission delay difference.

12. The measurement method according to claim 11, wherein the MGL further comprises a measurement window duration and a radio frequency adjustment duration.

13. The measurement method according to claim 10, wherein the measurement gap comprises a measurement gap offset, the measurement gap offset is configured based on the transmission delay difference, and measuring, based on the measurement gap, the reference signal for the neighboring cell corresponding to the neighboring cell identifier comprises:
determining a start moment of the measurement gap based on the measurement gap offset, and measuring, based on the start moment, the reference signal for the neighboring cell corresponding to the neighboring cell identifier.

14. The measurement method according to claim 10, wherein a plurality of groups of neighboring cells are arranged, a group of neighboring cells corresponds to one measurement gap respectively, and measuring, based on the measurement gap, the reference signal for the neighboring cell corresponding to the neighboring cell identifier comprises:
for one measurement gap, measuring, based on the measurement gap and the neighboring cell identifier corresponding to the measurement gap, the reference signal for one group of neighboring cells corresponding to the measurement gap.

15. The measurement method according to claim 14, wherein the measurement gap corresponding to one group of neighboring cells comprises an MGL, and the MGL corresponding to one group of neighboring cells comprises a maximum transmission delay difference in transmission delay differences corresponding to the group of neighboring cells.

16. The measurement method according to claim 14, wherein the measurement gap corresponding to each group of neighboring cells comprises a measurement gap offset, and the measurement gap offset corresponding to each group of neighboring cells is configured based on a minimum transmission delay difference in transmission delay differences corresponding to the group of neighboring cells.

17. (canceled)

18. (canceled)

19. A communication device, comprising a processor and a memory, the processor and the memory being mutually connected;
the memory being configured to store a computer program; and
the processor being configured to execute computer program to perform the measurement gap determination method of claim 1.

20. A computer readable storage medium, wherein the computer readable storage medium stores a computer program, and the computer program is executed by a processor to implement the measurement gap determination method according to claim 1.

21. A communication device, comprising a processor and a memory, the processor and the memory being mutually connected;
the memory being configured to store a computer program; and
the processor being configured to execute a computer program to:
receive measurement configuration information, wherein the measurement configuration information comprises a measurement gap and a neighboring cell identifier corresponding to the measurement gap, and the measurement gap is determined based on a transmission delay difference between a serving cell and a neighboring cell; and
measure, based on the measurement gap, a reference signal for the neighboring cell corresponding to the neighboring cell identifier.

22. The communication device according to claim 21, wherein the measurement gap comprises a measurement gap length (MGL), and the MGL comprises the transmission delay difference.
